(19) United States
(12) Patent Application Publication
(10) Pub. No.: US 2025/0094438 A1
(43) Pub. Date: Mar. 20, 2025

(54) DATA FLOW OPTIMIZATION SYSTEM AND METHOD

(71) Applicants: INVENTEC (PUDONG) TECHNOLOGY CORPORATION, Shanghai (CN); INVENTEC CORPORATION, Taipei City (TW)

(72) Inventors: Yu-Lun CHANG, Taipei City (TW); Shu-Huei YANG, Taipei City (TW); Wei-Chao CHEN, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/545,398

(22) Filed: Dec. 19, 2023

(30) Foreign Application Priority Data
Sep. 14, 2023 (CN) 202311190904.0

(51) Int. Cl. G06F 16/25

(52) U.S. Cl. CPC G06F 16/254

(57) ABSTRACT

An optimization method for data flow includes converting a plurality of extract-transform-load (ETL) scripts into a data flow diagram, wherein the data flow diagram includes a plurality of data lineages, with each data lineage including a plurality of data nodes; performing a first merging process, which repeatedly identifies at least two data lineages with the same nodes and merges them into a data family until any two of the data lineages do not have the same nodes; performing a second merging process, which calculates a column similarity of a pair of node, wherein the pair of nodes includes two adjacent data nodes within a data lineage; when the column similarity exceeds a threshold, merging the two data nodes; when the column similarity of the pair of nodes falls below the threshold, the data flow diagram is optimized, which is then converted into ETL scripts accordingly.

### CROSS-REFERENCE TO RELATED APPLICATIONS

This non-provisional application claims priority under 35 U.S.C. § 119(a) on Patent Application No(s). 202311190904.0 filed in China on Sep. 14, 2023, the entire contents of which are hereby incorporated by reference.

### BACKGROUND

### 1. Technical Field

The present disclosure relates to data flow optimization, and more particular to a data flow optimization system and method.

### 2. Related Art

Data Extract-Transform-Load (ETL) process in large organization is complicated, as there are many heterogeneous data sources, different data structures, multiple data representations need to be cleaned, integrated, and quality-assured for later applications. Typically, the data pipeline is very long before it becomes ready to be consumed. The problems faced by the existing technology are as follows:

First, data flow could be better optimized: building pipelines requires so many interviews and intensive discussions on the scope, and often-revision due to real-world limitations prolongs implementation. Besides, in large and complicated organizations, the data flow designed by humans could not be optimized, with more redundancy and lower quality.

Second, not easy for human understanding: currently Structured Query Language (SQL) or SQL-like data processing is mainstream, however, it is hard to understand how the pipeline is connected by a quick glance. With Data Governance (DG) process involved, the pipeline connection could be documented, but in the end, it is manually created and updated, therefore very time consuming.

Third, hard to trace back and evaluate affected scope: it is difficult to trace back where an error occurs without reading detailed scripts line-by-line, or how many pipelines are affected when a small amount of defected data points downstream were discovered and need to be fixed.

Fourth, the existing data flow to the new system cannot be reused if an external solution is chosen: despite there are several sets of commercialized software that have graphical user interface to easily define or join related data for analytic usage, the existing data pipelines cannot be reused and must be rebuilt to align with the new system, leading to increased labor cost.

### SUMMARY

In view of the above, the present disclosure proposes a data flow optimization system and method to address the above-mentioned problems.

According to one or more embodiment of the present disclosure, a data flow optimization method, performed by a processor, includes: converting a plurality of extract-transform-load (ETL) scripts into a data flow diagram, wherein the data flow diagram includes a plurality of data lineages, and each of the plurality of data lineages includes a plurality of data nodes connected in a series; performing a first merging process to generate a plurality of data families, wherein the first merging process comprises: repeatedly finding at least two data lineages from the plurality of data lineages that have an identical node; and merging the at least two data lineages into one of the plurality of data families until any two of the plurality of data lineages do not have the identical node; after the first merging process is completed, performing a second merging process on each of the plurality of data lineages, wherein the second merging process comprises: calculating a column similarity of a node pair, wherein the node pair comprises two adjacent data nodes with the series; when the column similarity exceeds a first threshold, merging the two adjacent data nodes into one node; and when the column similarity of the node pair does not exceed the first threshold, the data flow diagram is optimized, which is then converted into ETL scripts accordingly.

According to one or more embodiment of the present disclosure, a data flow optimization system includes a storage device and a computing device. The storage device is configured to store a plurality of extract-transform-load scripts and a plurality of instructions. The computing device is electrically connected to the storage device and configured to execute the plurality of instructions to perform a plurality of operations, wherein the plurality of instructions includes: converting a plurality of extract-transform-load (ETL) scripts into a data flow diagram, wherein the data flow diagram includes a plurality of data lineages, each of the plurality of data lineages includes a plurality of data nodes connected in a series; performing a first merging process to generate a plurality of data families, wherein the first merging process comprises: repeatedly finding at least two data lineages from the plurality of data lineages that have an identical node; and merging the at least two data lineages into one of the plurality of data families until any two of the plurality of data lineages do not have the identical node; after the first merging process is completed, performing a second merging process on each of the plurality of data lineages, wherein the second merging process comprises: calculating a column similarity of a node pair, wherein the node pair comprises two adjacent data nodes with the series; when the column similarity exceeds a first threshold, merging the two adjacent data nodes into one node; and when the column similarity of the node pair does not exceed the first threshold, the data flow diagram is optimized, which is then converted into ETL scripts accordingly.

In view of the above, the data flow optimization system and method proposed in the present disclosure effectively reduce the number of data tables, thereby lowering the hardware costs of storing these data tables and improving the computational speed after loading the data tables. The present disclosure can efficiently and automatically generate data flow diagrams and offers the following benefits:

First, automated and optimized: the system automatically generates the designed data flow, so that users can focus solely on defining their demands of business operations or data applications. The flow graph is optimized and integrated for complex scope of data inputs and outputs. Furthermore, the process automation means to revise the flow, to regenerate the data, and to test on the pipeline are easier and faster.

Second, visualized and documented: the visualized data lineage is better for human understanding, especially when debugging on missing or misaligned data. Also, it assures DG compliance of the resulting documentation. On the other hand, from data analytics point of view, users can design or fine-tune desired data flow with GUI as it is digitalized.

Third, support for impact analysis: the generated data lineage is down to column-wised connection. Therefore, when debugging or updating the flow, it is easy to highlight the related pipelines for human understanding, which also means that the revision can be automatically under human supervision.

Fourth, reusable: the evolved data pipelines are compatible with old systems as the existing data flows can be included for system optimization and integration.

The aforementioned context of the present disclosure and the detailed description given herein below are used to demonstrate and explain the concept and the spirit of the present application and provides the further explanation of the claim of the present application.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of the data flow optimization system according to an embodiment of the present disclosure;

FIG. 2 is a flowchart of the data flow optimization method according to an embodiment of the present disclosure;

FIG. 3 is an example of a data flow diagram;

FIG. 4 is an example of a data family;

FIG. 5 is a flowchart of the first merging process according to an embodiment of the present disclosure;

FIG. 6 is a flowchart of the second merging process according to an embodiment of the present disclosure;

FIG. 7 is a flowchart of the column similarity calculation according to an embodiment of the present disclosure;

FIG. 8 is a flowchart of the data flow optimization method according to another embodiment of the present disclosure; and

FIG. 9 is a flowchart of the third merging process according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

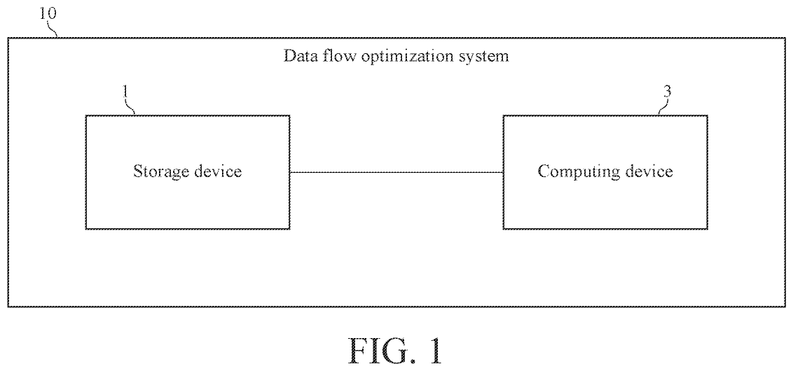

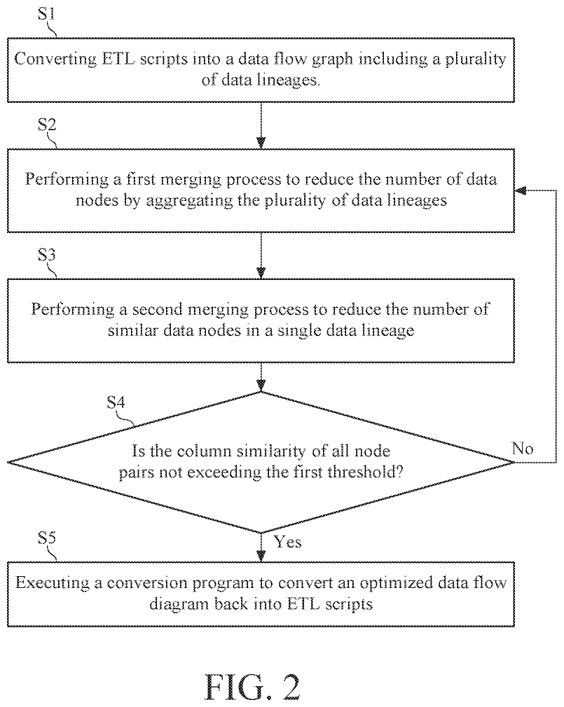

FIG. 1 is a block diagram of the data flow optimization system according to an embodiment of the present disclosure. As shown in FIG. 1. As shown in FIG. 1, the system 10 includes a storage device 1 and a computing device 3. The storage device 1 is configured to store a plurality of Extract-Transform-Load (ETL) scripts and a plurality of instructions. The computing device 3 is electrically connected to the storage device 1. The computing device 3 is configured to execute the plurality of instructions to perform a plurality of operations. Regarding the process corresponding to the plurality of operations, please refer to FIG. 2

In an embodiment, the storage device 1 may be volatile and/or non-volatile memory. Non-volatile memory includes Read-Only Memory (ROM), Programmable ROM (PROM), Electrically Programmable ROM (EPROM), Electrically Erasable and Programmable ROM (EEPROM), flash memory, Phase-Change Random Access Memory (PRAM), Magnetic RAM (MRAM), Resistive RAM (RRAM), and/or Ferroelectric RAM (FRAM). Volatile memory may include Dynamic RAM (DRAM), Static RAM (SRAM), and/or Synchronous DRAM (SDRAM). In another embodiment, the storage device 1 may be at least one of the hard disk drive (HDD), solid-state drive (SSD), compact flash (CF) card, secure digital (SD) card, microSD card, miniSD card, extreme digital (xD) card, and memory sticks.

In an embodiment, the computing device 3 may be implemented as one or more of the following examples: personal computer, network server, microcontroller (MCU), application processor (AP), Field Programmable Gate Array (FPGA), Application Specific Integrated Circuit (ASIC), System-on-a-Chip (SOC), deep learning accelerator, or any electronic device with similar functionality. The present disclosure does not limit the hardware type of the computing device 3.

FIG. 2 is a flowchart of the data flow optimization method according to an embodiment of the present disclosure. As shown in FIG. 2, this method includes steps S1 to S5.

In step S1, the computing device 3 executes a conversion program to convert the ETL script into a data flow graph.

In an embodiment, the ETL script is a Structured Query Language (SQL) script, and the conversion program is python SQLLineage. However, the present disclosure is not limited to the examples mentioned above.

The plurality of ETL scripts are configured to operate on a plurality of source tables in the database, converting them into destination tables.

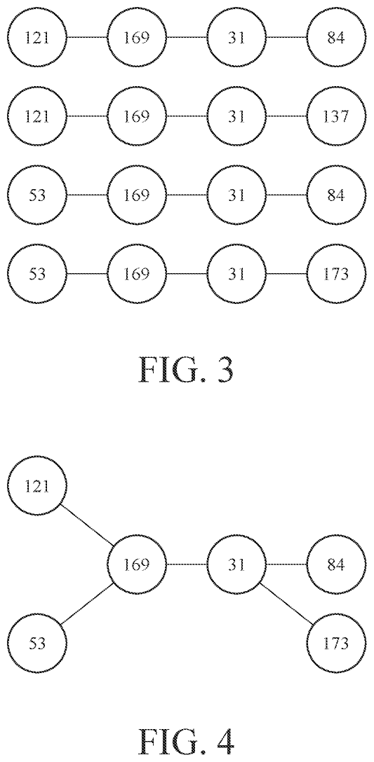

FIG. 3 is an example of a data flow graph. As shown in FIG. 3, the data flow graph includes a plurality of data lineages. Each data lineage includes a plurality of data nodes connected in a series. Each data node denotes a data table, depicted as a circle in FIG. 3. The numbers in the circles denotes data table IDs, and the connections between two data nodes denote the relationships between data tables. These relationships may involve actions such as extracting two out of three columns from table 121 to create table 69. The node 121 and the node 53 in FIG. 3 can be viewed as source data tables, while the node 84 and the node 173 can be viewed as destination data tables.

The input-output schemas are predefined during demand analysis at the beginning stage of Data Governance (DG) process. However, as the data pipelines grow, there could be similar data columns or tables, or replicated data flow sub-graphs. The target of the present disclosure is to integrate them. The existing data nodes are then regrouped by an unsupervised clustering method with features such as content similarity (column-wise), traverse similarity (table-wise), connections to the output nodes, and column attribute (e.g., text columns or numeric columns).

In step S2, the computing device 3 performs a first merging process to reduce the number of data nodes (data tables) by aggregating the plurality of data lineages, and the aggregation result is referred to as a data family. An example of FIG. 4 shows a data family, which is the result of performing the first merging process based on the example of FIG. 3.

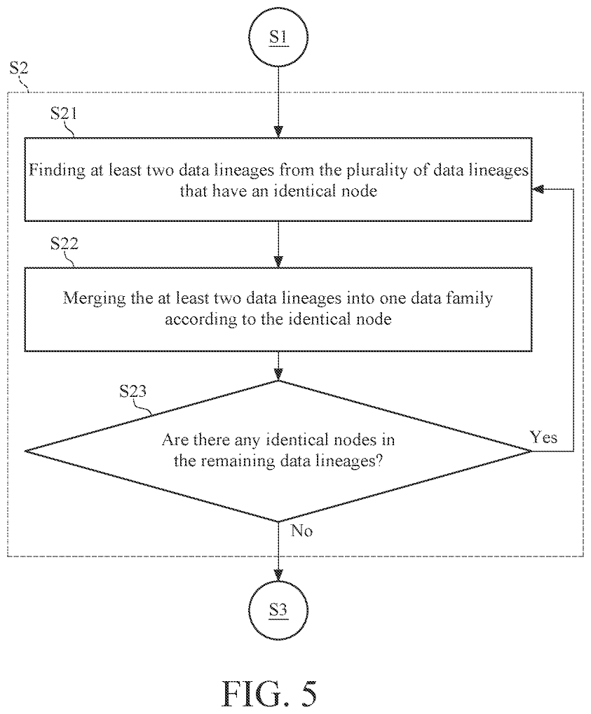

Specifically, the first merging process is shown as the flowchart of FIG. 5.

In step S21, finding at least two data lineages from the plurality of data lineages that have an identical node. The term “identical node”, for example, refers to the node 169 and the node 31 in FIG. 3.

In step S22, merging at least two data lineages with the identical node into one data family.

In step S23, determining if there are still identical nodes in the remaining data lineages. If yes, return to step S21; if not, continue to step S3. In other words, the first merging process is repeated until no two data lineages have an identical node. After the first merging process of step S2 is completed, proceed to step S3.

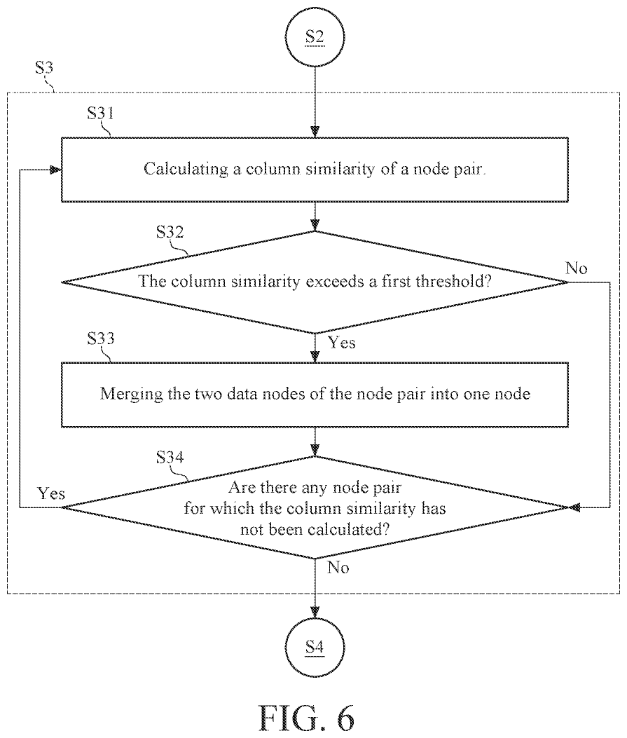

In step S3, the computing device 3 performs a second merging process on each data lineage to reduce the number of similar data nodes in a single data lineage. Specifically, the second merging process is shown as the flowchart of FIG. 6.

In step S31, calculating a column similarity of a node pairs. The node pair consists of two adjacent data nodes in a lineage. For example, the node 121 and the node 169 form one node pair, and the node 169 and the node 31 form another node pair.

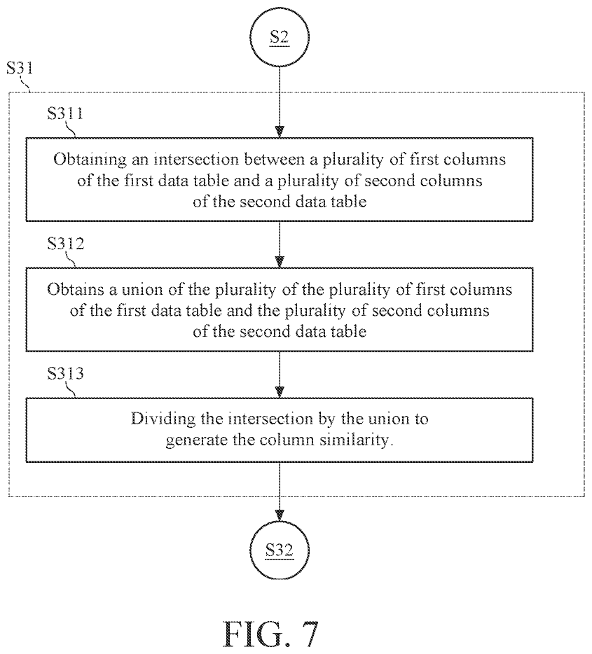

FIG. 7 is a flowchart of the column similarity calculation according to an embodiment of the present disclosure, including steps S311 to S313.

In step S311, the computing device 3 obtains an intersection between a plurality of first columns of the first data table and a plurality of second columns of the second data table, where the first data table corresponds to one node in a node pair, and the second data table corresponds to the other node in the node pair. The first columns and second columns represent the lists of data columns in the first table and second table, respectively.

In step S312, the computing device 3 obtains a union of the plurality of first columns of the first data table and the plurality of second columns of the second data table.

In step S313, the computing device 3 divides the intersection by the union to generate the column similarity.

The first data table and the second data table correspond to two adjacent data nodes in a series. In the example of FIG. 3, assuming the node 121 is the first data table containing three first columns: {C1, C2, C3}, and the node 169 is the second data table containing three second columns: {C2, C3, C4}.

Therefore, the intersection obtained in step S311 is {C2, C3}, the union obtained in step S312 is {C1, C2, C3, C4}, and the column similarity calculated in step S313 is 2/4=0.5.

In step S32, the computing device 3 determines if the column similarity exceeds a first threshold. According to the calculation method described above, a higher similarity value indicates a higher similarity between two data tables. In an embodiment, the first threshold is set between 0 and 1, and the present disclosure does not specifically limit its value.

In step S33, since the column similarity exceeds the first threshold, the computing device 3 merges the two data nodes of the node pair into one node. In an embodiment, the merging process involves retaining one of the two data nodes and deleting the other.

In step S34, the computing device 3 determines whether there are any node pairs for which the column similarity has not been calculated. If yes, the next node pair is selected, and the process returns to step S31. If not, the process continues to step S4.

In step S4, the computing device 3 determines if all node pairs have column similarities that do not exceed the first threshold. If yes, the process proceeds to step S5. If not, the process returns to step S2.

In step S5, the computing device 3 executes a conversion program to convert an optimized data flow diagram back into ETL scripts. The converted ETL scripts are referred to as an optimized script because they have significantly reduced the number of identical or similar data tables. In an embodiment, the conversion program used in step S5 is the same as that used in step S1.

In the implementation of the data flow optimization method shown in FIG. 2, through the first merging process and the second merging process, duplicated or highly similar data tables can be effectively identified, reducing the number of redundant nodes in the data flow.

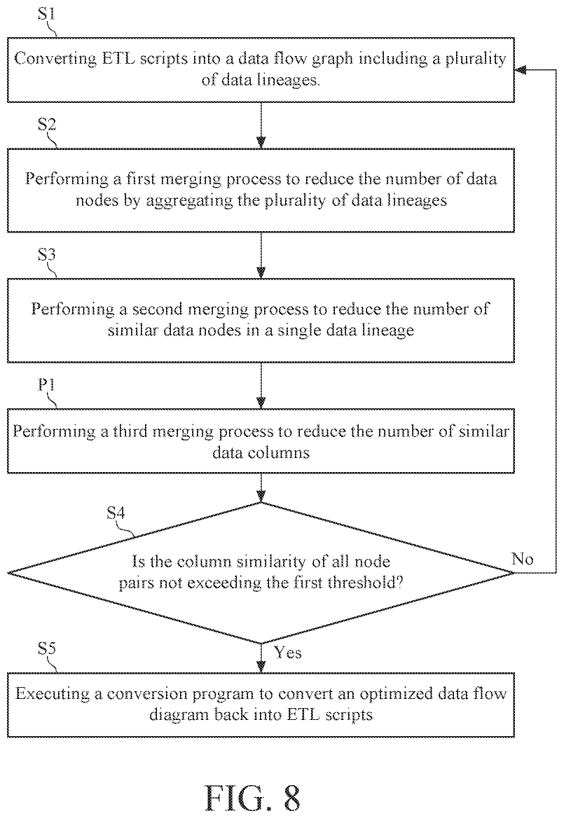

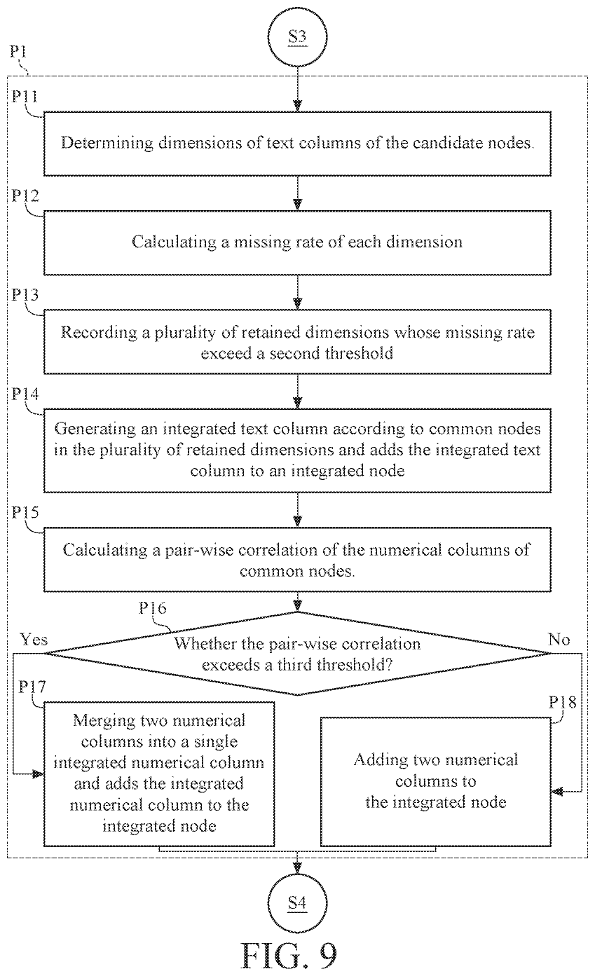

FIG. 8 is a flowchart of the data flow optimization method according to another embodiment of the present disclosure. In contrast to the embodiment of FIG. 2, the embodiment of FIG. 8 adds step P1 after step S3. In step P1, the computing device 3 performs a third merging process on each data family to reduce the number of similar data columns.

Each time the data family used for the third merging process is referred to as a candidate data family. A candidate data family includes a plurality of candidate nodes. Each candidate node denotes a data table; this data table includes a plurality of data columns. The plurality of data columns come in at least two types: text-type columns and numeric-type columns. The third merging process begins with the integration of text columns. Table 1 below provides an example showing a plurality of candidate nodes, each containing several text columns. For example, the candidate node 1 includes only one text column: BU. The candidate node 2 includes four text columns: MANUFACTURE, CLASS_CODE_PROC_COMMODITY, CLASSCODE, and PCA. Since there is no text column similar to BU, the first entry of the candidate node 2 is blank.

Table 1, an example of text columns of the candidate nodes.

| Node 1 | Node 2 | Node 3 | Node 4 | Node 5 | Node 6 |
|---|---|---|---|---|---|
| BU | | BU_CODE | | BU | BU |
| | MANUFACTURE | | | VENDOR | |
| | CLASS_CODE_PROC_COM- | | | PROC_COMMODITY | |
| | MODITY | | | | |
| | CLASSCODE | | | CLASS_CODE | CLASS_CODE |
| | | VENDOR | VENDOR_CODE | | |
| | | | MATERIAL | | |
| | PCA | | | | PCA |
| | | MANUFACTURE_AVLID | | MANUFACTURE_AVLID | |

FIG. 9 is a flowchart of the third merging process according to an embodiment of the present disclosure, including steps P11 to P18.

In step P11, the computing device 3 determines dimensions of text columns of the candidate nodes. During data governance, different individuals may use data tables differently, resulting in originally identical text columns being modified into different forms. Therefore, in an embodiment, as shown in Table 1, all the text columns of all candidate nodes (Node 1 to Node 6) are listed, and then the dimensions corresponding to text columns are manually determined. In another embodiment, the dimensions corresponding to text columns can be automatically determined according to a pre-defined dimension setting table. Table 2 below provides an example of the dimension setting table.

Table 2, an example of the dimension setting table.

| Dim. | | | | | | |
|---|---|---|---|---|---|---|
| group | Organization | Time | Site | Vendor | Class code | Material |
| 1 | BU | Daily | SITE | VENDOR | CLASS_CODE | MATERIAL |
| | BU_CODE | | PLANT_CODE | VENDOR_CODE | CLASS_CODE_PROC_COMMODITY | PCA |
| 2 | | Weekly | SITE_NAME | MANUFACTURE | | |
| 3 | | Monthly | | MANUFACTURE_AVLID | | |
| 4 | | Quarterly | | | | |

For example, from Table 2, it can be observed that both the text column BU of the candidate node 1 and the text column BU_CODE of the candidate node 3 correspond to the dimension “Organization”; both the text column MANUFACTURE of the candidate node 2 and the text column VENDER of the candidate node 3 correspond to the dimension “Vendor”, and so on. Therefore, the computing device 3 can automatically determine the dimension corresponding to each text column using a string matching algorithm and the dimension setting table.

In step P12, the computing device 3 calculates a missing rate of each dimension. The missing rate is the number of candidate nodes of a certain dimension corresponding to a certain text column divided by the total number of candidate nodes. For example, based on Tables 1 and 2, Table 3 below provides an example of the dimension distribution of candidate nodes. As shown in Table 3, each of the candidate nodes 1, 3, 5, and 6 has one text column corresponding to the dimension “Organization”, and each of the candidate nodes 2, 3, 4, and 5 has one text column corresponding to the dimension “Manufacturer”. Based on the example of Table 3, the missing rates of the dimensions “Organization” and “Vendor” are both 4/6≈0.66, and the missing rates of the dimensions “Class code” and “Material” are both 3/6=0.5.

It should be noted that in Table 1, the candidate node 2 includes two different text columns, CLASS_CODE_PROC_COMMODITY and CLASSCODE, which both belong to the same dimension “Class code” as indicated by the dimension setting table in Table 2. Therefore, these two text columns can be merged into one in the subsequent steps.

Table 3, an example of dimension distribution of the candidate nodes.

| Node 1 | Node 2 | Node 3 | Node 4 | Node 5 | Node 6 |
|---|---|---|---|---|---|
| Organi- | | Organi- | | Organi- | Organi- |
| zation | | zation | | zation | zation |
| | Vendor | Vendor | Vendor | Vendor | |
| | Class code | | | Class code | Class code |
| | Material | | Material | | Material |

In step P13, the computing device 3 records a plurality of retained dimensions whose missing rate exceeds a second threshold, where the plurality of retained dimensions includes at least two of the plurality of dimensions. In an embodiment, the second threshold is 0.5, so the computing device 3 records the dimensions “Organization” and “Vendor” as the retained dimensions.

In step P14, the computing device 3 generates an integrated text column according to common nodes in the plurality of retained dimensions and adds the integrated text column to an integrated node. As shown in Table 3, regarding the two retained dimensions “Organization” and “Vendor”, the common nodes are the candidate nodes 3 and 5. Therefore, the text column BU_CODE of the candidate node 3 and the text column BU of the candidate node 5 can be merged into one integrated text column BU, and the text columns VENDOR, MANUFACTURE_AVLID of candidate 3, the node and VENDOR, MANUFACTURE_AVLID of the candidate node 5 can be merged into another integrated text column VENDOR. In an embodiment, “merging” refers to retaining one of the plurality of text columns to be merged because the information in these text columns is essentially the same. Table 4 below provides an example of integrated nodes. Integrated nodes also represent a data table, serving as a large data table that integrates a plurality of raw data tables (such as candidate nodes 3 and 5).

Table 4, an example of integrated nodes.

Integrated node

Integrated text column BU
Integrated text column VENDER
Integrated numeric column (A1, B1)
Numeric column (A2)
Numeric column (A3)
Numeric column (B2)

In step P15, the computing device 3 calculates a pair-wise correlation of the numerical columns of common nodes. The calculation of the pair-wise correlation includes: selecting two nodes from the plurality of common nodes, selecting one numerical column from each of these two nodes, and then calculating the correlation between these two numerical columns. For example, if the candidate node 3 includes three numerical columns A1, A2, and A3, and the candidate node 5 includes two numerical columns B1 and B2, the computing device 3 will calculate six pair-wise correlations, including the correlation between A1 and B1, A1 and B2, A2 and B1, A2 and B2, A3 and B1, and A3 and B2.

In step P16, the computing device 3 determines whether the pair-wise correlation exceeds a third threshold. If the determination is “yes”, then step P17 is performed. If the determination is “no”, then step P18 is performed.

In step P17, the computing device 3 merges two numerical columns with pair-wise correlations greater than the third threshold into a single integrated numerical column and adds the integrated numerical column to the integrated node. As shown in the example of Table 4, the numerical columns A1 and B1 can be merged into a single integrated numerical column.

In step P18, the computing device 3 adds two numerical columns with pair-wise correlations not greater than the third threshold to the integrated node. As shown in the example of Table 4, since the pair-wise correlations between any two of the numerical column A2 of node 3, the numerical column A3 of node 3, and the numerical column B2 of node 5 is not greater than the third threshold, these numerical columns A2, A3, and B2 are added to the integrated node after processing the integrated text columns and the integrated numerical columns.

Overall, in the third merging process shown in FIG. 9, first, a part of data tables is selected from the plurality of data tables, where the text columns of these data tables have common dimensions and can be merged into an integrated node. Then, among the numerical columns of the selected data tables, pair-wise correlations are calculated, and the numerical columns with high correlations are selected for merging and added to the integrated node. By executing the third merging process on the plurality of data tables of each data family, the number of data columns can be effectively reduced.

In view of the above, the data flow optimization system and method proposed in the present disclosure effectively reduce the number of data tables, thereby lowering the hardware costs of storing these data tables and improving the computational speed after loading the data tables. The present disclosure can efficiently and automatically generate data flow diagrams and offers the following benefits:

First, automated and optimized: the system automatically generates the designed data flow, so that users can focus solely on defining their demands of business operations or data applications. The flow graph is optimized and integrated for complex scope of data inputs and outputs. Furthermore, the process automation means to revise the flow, to regenerate the data, and to test on the pipeline are easier and faster.

Second, visualized and documented: the visualized data lineage is better for human understanding, especially when debugging on missing or misaligned data. Also, it assures DG compliance of the resulting documentation. On the other hand, from data analytics point of view, users can design or fine-tune desired data flow with GUI as it is digitalized.

Third, support for impact analysis: the generated data lineage is down to column-wised connection. Therefore, when debugging or updating the flow, it is easy to highlight the related pipelines for human understanding, which also means that the revision can be automatically under human supervision.

Fourth, reusable: the evolved data pipelines are compatible with old systems as the existing data flows can be included for system optimization and integration.

Although embodiments of the present application are disclosed as described above, they are not intended to limit the present application, and a person having ordinary skill in the art, without departing from the spirit and scope of the present application, can make some changes in the shape, structure, feature and spirit described in the scope of the present application. Therefore, the scope of the present application shall be determined by the scope of the claims.

What is claimed is:

1. A data flow optimization method, performed by a processor, comprising:
converting a plurality of extract-transform-load scripts into a data flow diagram, wherein the data flow diagram includes a plurality of data lineages, and each of the plurality of data lineages includes a plurality of data nodes connected in a series;
performing a first merging process to generate a plurality of data families, wherein the first merging process comprises: repeatedly finding at least two data lineages from the plurality of data lineages that have an identical node; and merging the at least two data lineages into one of the plurality of data families until any two of the plurality of data lineages do not have the identical node;
after the first merging process is completed, performing a second merging process on each of the plurality of data lineages, wherein the second merging process comprises: calculating a column similarity of a node pair, wherein the node pair comprises two adjacent data nodes with the series; when the column similarity exceeds a first threshold, merging the two adjacent data nodes into one node; and
when the column similarity of the node pair does not exceed the first threshold, converting the data flow diagram back into an optimized script.

2. The data flow optimization method for data flow performed of claim 1, further comprising:
after the second merging process is completed, performing a third merging process on a candidate data family, wherein the candidate data family is each of the plurality of data families, the candidate data family comprises a plurality of candidate nodes, each of the plurality of candidate nodes denotes a data table, the data table comprises a plurality of text columns and a plurality of numeric columns, and the third merging process comprises:
determining a plurality of dimensions corresponding to the plurality of text columns respectively;
calculating a missing rate of each of the plurality of dimensions, wherein the missing rate is a number of candidate nodes of one of the plurality of dimensions corresponding to one of the plurality of text columns divided by a total number of the plurality of candidate nodes;
recording a plurality of retained dimensions whose missing rate exceeds a second threshold, wherein the plurality of retained dimensions comprises at least two of the plurality of dimensions;
generating an integrated text column according to a plurality of common nodes in the plurality of retained dimensions and adding the integrated text column to an integrated node, wherein the plurality of common nodes comprises at least two of the plurality of candidate nodes;
calculating a pair-wise correlation of the plurality of common nodes, wherein the pair-wise correlation is a correlation between one of the plurality of numeric columns of one of the plurality of common nodes and one of the plurality of numeric columns of another one of the plurality of common nodes;
merging two of the plurality of numeric columns into an integrated numeric column and adding the integrated numeric column to the integrated node when the pair-wise correlation exceeds than a third threshold; and
adding two of the plurality of numeric columns to the integrated node when the pair-wise correlation does not exceed the third threshold.

3. The data flow optimization method for data flow performed of claim 1, wherein calculating the column similarity of the node pair comprises:
obtaining an intersection between a plurality of first columns of a first data table and a plurality of second columns of a second data table, wherein the first data table and the second data table respectively correspond to the two adjacent data nodes of the plurality of data nodes in the series;
obtaining a union between the plurality of first columns and the plurality of second columns; and
dividing the intersection by the union to generate the column similarity.

4. The data flow optimization method for data flow performed of claim 1, wherein the plurality of extract-transform-load scripts is structured query language script.

5. The data flow optimization method for data flow performed of claim 1, wherein converting the plurality of extract-transform-load scripts into the data flow diagram is done using python SQLLineage.

6. A data flow optimization system comprising:
a storage device configured to store a plurality of extract-transform-load scripts and a plurality of instructions; and
a computing device electrically connected to the storage device and configured to execute the plurality of instructions to perform a plurality of operations, wherein the plurality of instructions comprises:
converting a plurality of extract-transform-load scripts into a data flow diagram, wherein the data flow diagram includes a plurality of data lineages, each of the plurality of data lineages includes a plurality of data nodes connected in a series;
performing a first merging process to generate a plurality of data families, wherein the first merging process comprises: repeatedly finding at least two data lineages from the plurality of data lineages that have an identical node; and merging the at least two data lineages into one of the plurality of data families until any two of the plurality of data lineages do not have the identical node;
after the first merging process is completed, performing a second merging process on each of the plurality of data lineages, wherein the second merging process comprises: calculating a column similarity of a node pair, wherein the node pair comprises two adjacent data nodes with the series; when the column similarity exceeds a first threshold, merging the two adjacent data nodes into one node; and
when the column similarity of the node pair does not exceed the first threshold, converting the data flow diagram back into an optimized script.

7. The data flow optimization system of claim 6, wherein the plurality of instructions further comprises:
after the second merging process is completed, performing a third merging process on a candidate data family, wherein the candidate data family is each of the plurality of data families, the candidate data family comprises a plurality of candidate nodes, each of the plurality of candidate nodes denotes a data table, the data table comprises a plurality of text columns and a plurality of numeric columns, and the third merging process comprises:
determining a plurality of dimensions corresponding to the plurality of text columns respectively;
calculating a missing rate of each of the plurality of dimensions, wherein the missing rate is a number of candidate nodes of one of the plurality of dimensions corresponding to one of the plurality of text columns divided by a total number of the plurality of candidate nodes;
recording a plurality of retained dimensions whose missing rate exceeds a second threshold, wherein the plurality of retained dimensions comprises at least two of the plurality of dimensions;
generating an integrated text column according to a plurality of common nodes in the plurality of retained dimensions and adding the integrated text column to an integrated node, wherein the plurality of common nodes comprises at least two of the plurality of candidate nodes;
calculating a pair-wise correlation of the plurality of common nodes, wherein the pair-wise correlation is a correlation between one of the plurality of numeric columns of one of the plurality of common nodes and one of the plurality of numeric columns of another one of the plurality of common nodes;
merging two of the plurality of numeric columns into an integrated numeric column and adding the integrated numeric column to the integrated node when the pair-wise correlation exceeds than a third threshold; and
adding two of the plurality of numeric columns to the integrated node when the pair-wise correlation does not exceed the third threshold.

8. The data flow optimization system of claim 6, wherein calculating the column similarity of the node pair comprises:
obtaining an intersection between a plurality of first columns of a first data table and a plurality of second columns of a second data table, wherein the first data table and the second data table respectively correspond to the two adjacent data nodes of the plurality of data nodes in the series;
obtaining a union between the plurality of first columns and the plurality of second columns; and
dividing the intersection by the union to generate the column similarity.

9. The data flow optimization system of claim 6, wherein the plurality of extract-transform-load scripts is structured query language script.

10. The data flow optimization system of claim 6, wherein converting the plurality of extract-transform-load scripts into the data flow diagram is done using python SQLLineage.
